(19) United States
(12) Patent Application Publication
(10) Pub. No.: US 2015/0096946 A1
(43) Pub. Date: Apr. 9, 2015

(54) Separator and method for treatment of a contaminated liquid

(71) Applicant: Barry Ross DUNMAN, Somerset Wes (ZA)

(72) Inventor: Barry Ross Dunman, Somerset West (ZA)

(21) Appl. No.: 14/399,390

(22) PCT Filed: Apr. 30, 2013
(86) PCT No.: PCT/ZA2013/000030

§ 371 Date: Nov. 6, 2014

(30) Foreign Application Priority Data
May 16, 2012 (ZA) 2012/03558

(51) Int. Cl. B04C 3/06; B01D 21/26

(52) U.S. Cl. CPC B04C 3/06; B01D 21/267
USPC 210/787; 210/194

(57) ABSTRACT

Separator apparatus and method for treatment of a contaminated liquid by injecting air/gas to lower the specific gravity of the contaminated liquid by at least 20% and rotating the contaminated liquid to separate contaminants by centrifugal forces. The separator includes a swirl chamber defining a longitudinal axis; at least one injector for, in use, introducing: (i) liquid entrained with air/gas; (ii) air/gas-entrained liquid; or (iii) air/gas, into the swirl chamber; a first outlet located at or near the operative bottom of the swirl chamber for, in use, removing sludge from the swirl chamber; a second outlet located operatively above the first outlet for, in use, removing liquid from the swirl chamber; circulating means to, in use, circulate liquid in the swirl chamber; and an elongate body that extends from or near the operative top of the swirl chamber, along the longitudinal axis of the swirl chamber, beyond the level of the at least one injector.

### BACKGROUND

The present invention relates to an apparatus and process for treatment of a contaminated liquid. More particularly, the present invention relates to an apparatus and process for removing contaminants from a contaminated liquid using a swirl chamber with injectors that inject air into contaminated liquid within the swirl chamber to: (i) reduce the specific gravity of the contaminated liquid; and (ii) rotate the contaminated liquid within the swirl chamber.

Separators including swirl chambers and high pressure jets are known. For instance, JP62201661 “Cyclone type solid-liquid separator” describes the use of nozzles to inject gas and liquid into a chamber to cause circulation of liquid therein. And, U.S. Pat. No. 4,279,743 “Air-sparged hydrocyclone and method” describes a hydrocyclone that injects air into an annular chamber surrounding a swirl chamber.

In most of the known systems, air is introduced into the separator to create froth and not materially to reduce the specific gravity of the contaminated liquid in the separator/swirl chamber so as to facilitate centrifugal separation of the contaminated liquid.

It is an aim of the present invention to improve centrifugal separation within a swirl chamber by materially lowering the specific gravity of the contaminated liquid therein.

### SUMMARY OF THE INVENTION

According to a first aspect of the present invention there is provided a separator that includes:
a swirl chamber defining a longitudinal axis;
at least one injector for, in use, introducing: (i) liquid entrained with air/gas; (ii) air/gas-entrained liquid; or (iii) air/gas, into the swirl chamber;
a first outlet located at or near the operative bottom of the swirl chamber for, in use, removing sludge from the swirl chamber;
a second outlet located operatively above the first outlet for, in use, removing liquid from the swirl chamber;
circulating means to, in use, circulate liquid in the swirl chamber; and
an elongate body that extends from or near the operative top of the swirl chamber, along the longitudinal axis of the swirl chamber, beyond the level of the at least one injector.

Typically, the operative upper portion of the swirl chamber is right circular cylindrical and the operative lower portion of the swirl chamber is right circular conical.

Generally, the at least one injector injects fluid into the swirl chamber otherwise than directly towards the longitudinal axis of the swirl chamber.

Preferably, the angularly offset orientation of the at least one injector relative to the radius of the swirl chamber, in use, causes the contaminated liquid within the swirl chamber to swirl, and comprises the circulating means.

Typically, the separator includes at least two injectors.

Preferably, the at least two injectors are arranged such that, in use, the direction of the liquid injected thereby is angularly offset relative to the radius of the swirl chamber by between 20 degrees and 46 degrees, more preferably, by between 26 degrees and 40 degrees, and most preferably at 33 degrees.

Generally, the elongate body is right circular cylindrical.

Typically, the elongate body extends into the operative lower portion of the swirl chamber.

Preferably, the separator further includes a feed inlet for, in use, charging the swirl chamber with contaminated liquid.

Generally, the feed inlet is arranged to, in use, direct contaminated liquid tangentially into the swirl chamber.

Preferably, the second outlet: (i) is located at the operative top of the swirl chamber; (ii) is concentric with the longitudinal axis of the elongate body; and (iii) has a diameter greater than the diameter of the elongate body.

Generally, the separator further includes a flotation chamber located operatively above the swirl chamber and communicating therewith via the second outlet.

Typically, the flotation chamber includes: (i) a foam outlet for, in use, discharging foam from the flotation chamber; and (ii) a treated liquids outlet for discharging treated liquid from the flotation chamber.

Preferably, the flotation chamber comprises: (i) a first chamber for, in use, receiving liquid discharged from the swirl chamber via the second outlet, and from which the foam outlet, in use, discharges foam; and (ii) a second chamber in fluid communication with the first chamber via a duct or orifice, wherein, in use, the duct or orifice is operatively located below the foam outlet.

Generally, in use, the liquid level in the second chamber is below the level of the operative bottom of the foam outlet in the first chamber.

Typically, the treated liquid outlet receives treated liquid from near the top of the second chamber.

The separator may further include a feedback pipe that extracts liquid from the flotation chamber and feeds it to the at least one injector. This feedback pipe may extract treated liquid from the second chamber of the flotation chamber.

Preferably, the separator further includes at least one cylindrical shear plate concentric with the longitudinal axis of the swirl chamber, located within the lower portion of the swirl chamber, in use, to induce shear forces between the rotating contaminated liquid in this region of the swirl chamber and the cylindrical shear plate.

Generally, the separator includes a second cylindrical shear plate, the second cylindrical shear plate being concentric with the first cylindrical shear plate but having a diameter different to that of the first cylindrical shear plate.

The injectors may be located within the operative lower portion of the swirl chamber.

Optionally, the feed inlet is located between the at least one injector and the first outlet.

According to a second aspect of the present invention there is provided a method for treatment of contaminated liquid, which method includes the steps of:
charging a swirl chamber with a contaminated liquid;
circulating the liquid in the swirl chamber; and
injecting a quantity of gas/air into the contaminated liquid in the swirl chamber so as to reduce its specific gravity by at least 20%.

Typically, the quantity of gas/air injected into the contaminated liquid in the swirl chamber reduces the specific gravity of the contaminated liquid by at least 30%.

Generally, the method further includes the steps of discharging: (i) sludge from the swirl chamber via a first outlet; and (ii) liquid from the swirl chamber via a second outlet operatively located above the first outlet.

Preferably, the method further includes the step of separating the liquid exiting the swirl chamber via the second outlet into a foam component and a liquid component.

Optionally, the liquid component is injected into the swirl chamber together with the gas/air.

Generally, the method further includes the step of extracting at least a portion of the liquid from flotation chamber and injecting it as a fluid stream back into the swirl chamber together with the gas/air.

The treated liquid may be extracted from the second chamber of the flotation chamber and injected as a fluid stream back into the swirl chamber together with the gas/air.

Preferably, the fluid stream of: (i) liquid entrained with gas/air; or (ii) gas/air, injected into the swirl chamber is not directed at the longitudinal axis of the swirl chamber.

Typically, at least two fluid streams are injected into the swirl chamber via injectors.

Generally, the direction of the fluid streams injected into the swirl chamber is offset relative to the radius of the swirl chamber by between 20 degrees and 46 degrees (a), preferably, by between 26 degrees and 40 degrees, and most preferably at 33 degrees.

Typically, the injection of fluid streams into the swirl chamber causes the formation of a torus body within the contaminated liquid that rotates faster and is more aerated than the surrounding contaminated liquid.

Generally, the torus body has:
a major radius corresponding to:

[the radius of the swirl chamber in the area of the injectors]×sin(α); and
a minor radius corresponding to 0.5×the width of the fluid stream at a distance:

[the radius of the swirl chamber in the area of the injectors]×cos(α)
from the injector.

Preferably, the angle α is sufficiently small to ensure that:

[the radius of the swirl chamber in the area of the injectors<[the major radius of the torus body]+[the minor radius of the torus body].

Typically, the radial outer peripheral surface of the torus body is spaced from the inner wall of the swirl chamber.

### BRIEF DESCRIPTION OF THE DRAWINGS

A preferred embodiment of the invention will now be described in more detail by way of example only, with reference to the accompanying drawing in which:

FIG. 1 is an upper perspective cross-sectional view of a separator according to a preferred embodiment of the first aspect of the invention;

FIG. 2 is a lower perspective cross-sectional view of the separator in FIG. 1;

FIG. 3 is a side cross-sectional view of the separator in FIG. 1;

FIG. 4 is a side cross-sectional view of the separator in FIG. 1, in use;

FIG. 5 is a plan view of the separator in FIG. 3 along line B-B, showing the formation of a torus therein; and

FIG. 6 is a plan view of the swirl chamber of the separator in FIG. 5, showing the motion of liquid and air bubbles therein.

### DESCRIPTION OF THE INVENTION

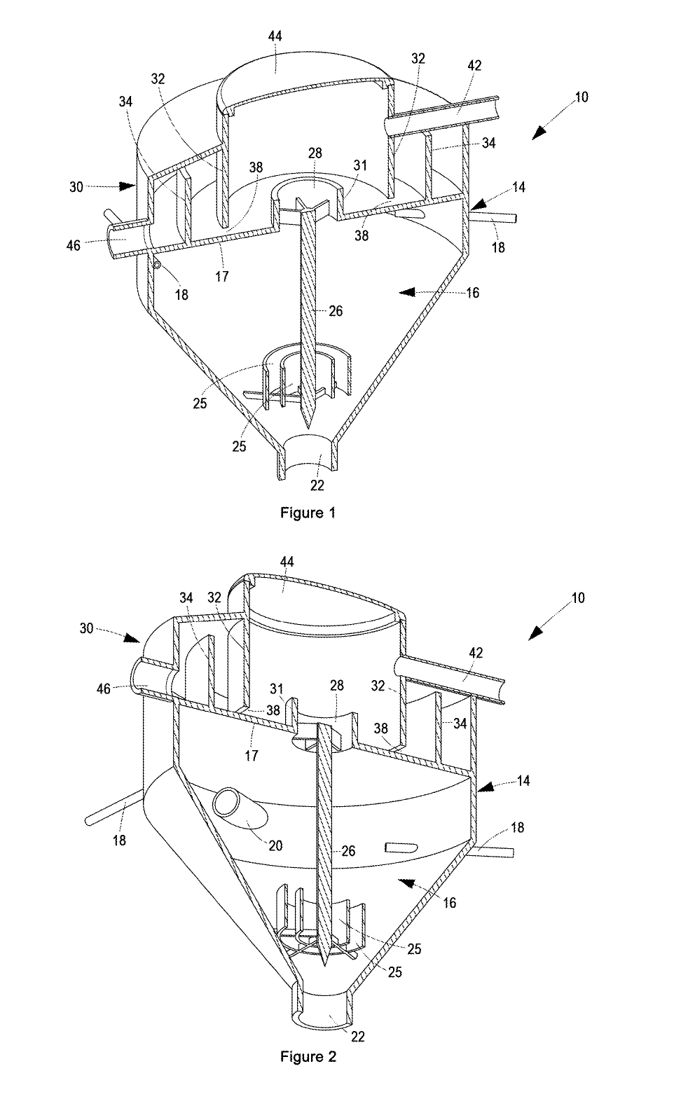

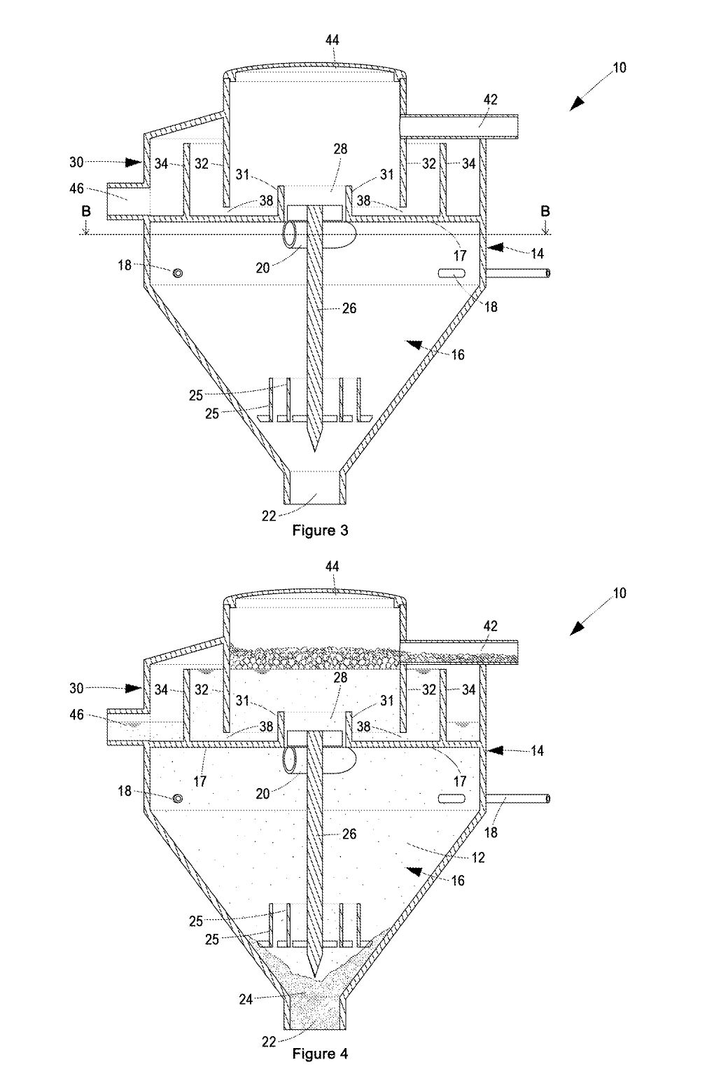

With reference to FIGS. 1 to 6, according to a preferred embodiment of a first aspect of the invention a separator 10 is provided to separate a contaminated liquid 12 using centrifugal force induced by rotation of the contaminated liquid 12 within the separator 10.

The separator 10 includes a hollow housing 14 defining a swirl chamber 16, and at least one injector 18 secured to the housing 14.

The swirl chamber 16 is divided into an operative upper portion and an operative lower portion. The operative upper portion of the swirl chamber 16 is right circular cylindrical, whereas the operative lower portion of the swirl chamber 16 is right circular conical. The operative top of the upper portion of the swirl chamber 16 is closed by a cover 17.

The operative upper portion of the swirl chamber 16 includes a feed inlet 20 for charging the swirl chamber 16 with contaminated liquid 12. The feed inlet 20 is arranged to direct contaminated liquid 12 tangentially into the swirl chamber 16.

A first outlet 22 is located at or near the operative bottom of the swirl chamber 16 (i.e. at or near the downward-facing apex of the right circular conical portion), in use, to discharge from the swirl chamber 16 liquid 12 or sludge 24 (shown in FIG. 4) that has settled at the bottom of the swirl chamber 16.

It will be appreciated that, to facilitate settling of sludge in the bottom portion of the swirl chamber 16, a series of cylindrical shear plates 25 of different diameters (and sharing the longitudinal axis of the swirl chamber 16) could be secured within the bottom portion of the swirl chamber 16. These cylindrical shear plates 25 generate shear forces (otherwise known as skin friction) between the rotating contaminated liquid 12/sludge 24 on the one hand and the cylindrical shear plates 25 on the other hand, thereby acting to slow the rotation of the contaminated liquid 12/sludge 24 in this region.

The Figures show a separator 10 with three injector 18. Each injector 18 injects (i) liquid with entrained air/gas; (ii) an air/gas entrained liquid; or (iii) air/gas, into the swirl chamber 16 in a direction otherwise than directly at the longitudinal axis of the swirl chamber 16. In other words, the injectors 18 do not inject air entrained liquid (otherwise referred to as a “fluid stream”) radially into the swirl chamber 16. In so doing, the injection of air entrained liquid via the injectors 18 causes the contaminated liquid 12 in the swirl chamber 16 to rotate.

Preferably, the injectors 18 inject liquid 12 entrained with air into the swirl chamber 16.

It will be appreciated that where a separator includes more than one injector 18, one of the injectors could inject only liquid into the swirl chamber 16.

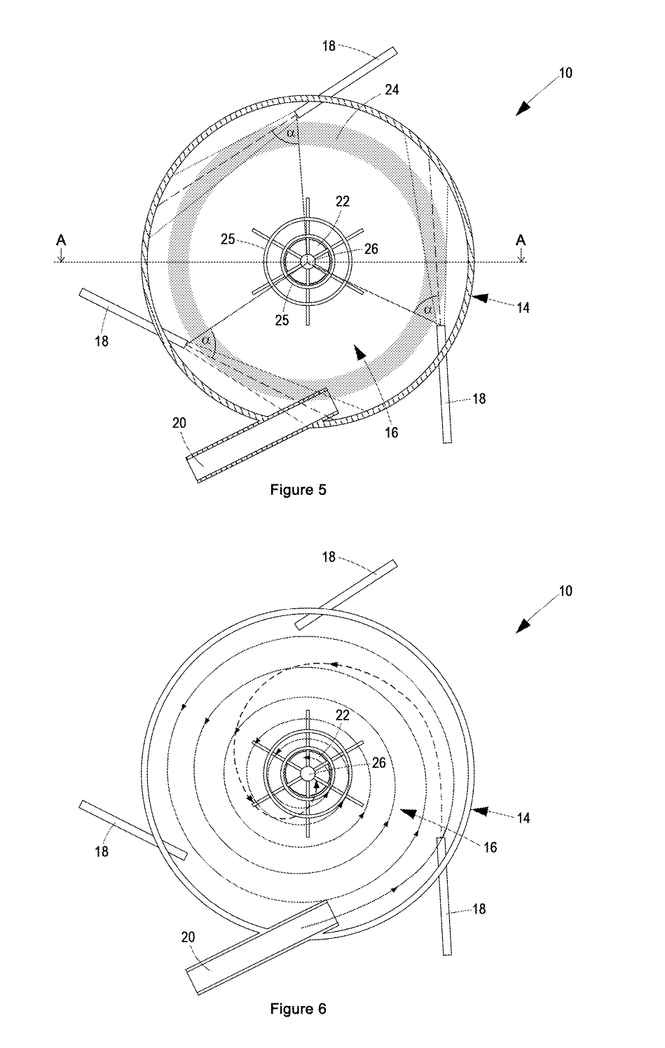

Turning specifically to FIG. 5, the more tangentially the injectors 18 are directed into the swirl chamber 16, the more the injection of air entrained liquid by the injectors 18 causes the contaminated liquid 12 within the swirl chamber 16 to rotate. However, in the preferred embodiment shown in the Figures, the injectors 18 are arranged such that the direction of the air entrained liquid injected thereby is angularly offset relative to the radius of the swirl chamber 16 (i.e. a) by between 20 degrees and 46 degrees, preferably between 26 degrees and 40 degrees, and most preferably at 33 degrees. All three injectors 18 are angularly offset relative to the radius of the swirl chamber 16 by the same amount. This arrangement causes the formation of a torus body 24 within the contaminated liquid 12 that rotates faster and is more aerated than the surrounding contaminated liquid 12. The torus body 24 has:
(i) a major radius corresponding to:

[the radius of the swirl chamber 16 in the area of the injectors 18]×sin(α); and
(ii) a minor radius corresponding to 0.5×the width of the stream of air entrained fluid at a distance:

[the radius of the swirl chamber 16 in the area of the injectors 18]×cos(α)
from the injector 18.

Importantly, the angle α should be sufficiently small to ensure that:

[the radius of the swirl chamber 16 in the area of the injectors 18]<[the major radius of the torus body 24]+[the minor radius of the torus body 24].

For, as long as this expression is TRUE, the radial outer peripheral surface of the torus body 24 will be spaced from the inner wall of the swirl chamber 16, ensuring no direct surface friction between contaminated liquid 12 within the torus body 24 and the inner wall of the swirl chamber 16.

To reduce direct surface friction, it is also important for the torus body 24 to be spaced from the cover 17.

Although the Figures show the injectors 18 located within the operative upper portion of the swirl chamber 16, it will be appreciated that the injectors could be located within the operative lower portion of the swirl chamber 16.

An elongate body 26 extends from or near the operative top of the swirl chamber 16 along the longitudinal axis of the swirl chamber 16 beyond the level of the injectors 18. The elongate body 26 is right circular cylindrical and either extends to the operative bottom of the swirl chamber 16 or terminates short from the bottom, but below the level of the injectors 18. This elongate body 26 assists the contaminated liquid 12 to rotate within the swirl chamber 16 around the elongate body 26.

A second outlet 28 is located operatively above the first outlet 22. FIGS. 1 to 4 (which are sectional views along line A-A of FIG. 5) show the second outlet 28 located at or near the operative top of the swirl chamber 16, extending through the centre of the swirl chamber cover 17. The diameter of the second outlet 28 is greater than the diameter of the elongate body 26 to define an annular aperture around the elongate body 26. In use, liquid with entrained gas/air exits the swirl chamber 16 through this second outlet 28.

The separator 10 further includes a flotation chamber 30 for separating entrained contaminant charged air bubbles from treated liquid exiting the swirl chamber 16 via the second outlet 28. The flotation chamber 30 comprises: (i) a first chamber defined by cylindrical wall 32 into which the second outlet 28, in use, discharges liquid exiting the swirl chamber 16 and from which a foam outlet 42, in use, discharges foam; and (ii) a second chamber defined between cylindrical walls 32 and 34, which second chamber is in fluid communication with the first chamber via a duct or orifice 38 operatively located below the foam outlet 42. In use, the liquid level in the second chamber is below the operative bottom of the foam outlet 42.

The separator 10 could include a feedback pipe (not shown) that extracts treated liquid 12 from the flotation chamber 30 (preferably, from the second chamber of the flotation chamber 30), and feeds it to the injectors 18. This is useful to permit continued circulation of contaminated liquid 12 within the separator 10 when the feed inlet 20 is closed/when there is no net inflow of contaminated liquid 12 into the swirl chamber 16 (i.e. the “no-flow” condition).

Efficiency of the separator 10 depends largely upon two factors (which are variable depending on the dimensions of the swirl chamber 16):
(i) the volume per unit time of air entrained liquid which may be discharged collectively by all injectors 18 within the swirl chamber 16; and
(ii) the velocity of air entrained liquid discharge by the injectors within the swirl chamber 16.

The “volume per unit time” has a direct bearing on the treatment capacity of the separator 10. Indicative values are shown in the table below:

| Diameter of swirl chamber (m) | 1 | 1.5 | 2 |
|---|---|---|---|
| Max capacity of all injectors (m³/Hr) | 40 | 95 | 170 |

The “velocity” of discharge from each injector 18 is preferably adjusted to a value of approximately 2× circumference of the swirl chamber 16. Indicative values are shown in the following table:

| Diameter of swirl chamber (m) | 1 | 1.5 | 2 |
|---|---|---|---|
| Ejection velocity at injectors (m/s) | 6 | 9 | 12 |

The collective action of all injectors 18 should result in a reduction in the specific gravity of the contaminated liquid 12 within the swirl chamber 16 of at least 20%, preferably of at least 25%, and more preferably of 30% or more.

Although the feed inlet 20 has been shown operatively located above the injectors 18, it will be appreciated that the feed inlet 20 could alternatively be operatively located below the level of the injectors 18 (i.e. between the injectors 18 and the first outlet 22). In this alternative arrangement (not shown): (i) solids (especially high specific gravity solids, such as sand) are quickly spun out of the torus body 24; and (ii) as the contaminated liquid 12 is required to pass the injectors 18 on its path from the feed inlet 20 to the second outlet 28, exposure of the contaminated liquid 12 from the feed inlet 20 to air injected by the injectors 18 is increased.

Turning specifically to FIG. 6 to describe the operation of the separator 10, prior to start up, the separator 10 should preferably be filled with clean water/liquid. If this step is omitted, a small amount of contaminated liquid 12 may flow through the second outlet 28 immediately after start of operation.

To start operation, contaminated liquid 12 is introduced into swirl chamber 16 through the feed inlet 20, said feed inlet 20 is arranged to provide a high velocity flow of contaminated liquid 12 into the swirl chamber 16 generally tangential to the swirl chamber 16 wall. The inflow from the feed inlet 20 may be encouraged by the stream of air entrained liquid ejected by the ejectors 18 and the shape of the swirl chamber 16 to move in a generally spiral path that decreases in radius as it moves operatively upwards until it reaches the second outlet 28 and is discharged from the swirl chamber 16. The solids settle downwards. The general path followed by the solids within the swirl chamber 16 is illustrated in FIG. 6 by means of solid arrows.

Turning to FIGS. 5 and 6, simultaneously with introduction of contaminated liquid 12, air is forced into the swirl chamber 16. Preferably, air in the form of fine bubbles entrained in treated liquid 12 is introduced into the swirl chamber 16 at high velocity by injectors 18. In this context, “fine bubbles” means bubbles preferably 0.1 mm diameter or less. The high velocity flow of air entrained liquid into the swirl chamber 16 (i.e. the fluid stream) causes the fluid stream to widen as it encounters the slower moving contaminated liquid 12 in the swirl chamber 16. This results in the upper portion of the swirl chamber 16 becoming filled with a rapidly rotating air/contaminated liquid 12 mixture. The air bubbles entrained in this mixture describe a different path through the swirl chamber 16 to that of the contaminated liquid 12. This occurs because the air bubbles possess a much lower specific gravity than that of the carrying liquid. The generally spiral path described by the air bubbles is that of the carrying liquid flow, modified by centrifugal action, which forces the fine air bubbles inwards toward the centre of the swirl chamber 16, across the flow of the carrying liquid. The path generally followed by the fine air bubbles is illustrated in FIG. 6 by means of a dotted line. An effect of the centrifugal action described above is relative motion between the contaminated liquid 12 and the fine air bubbles entrained therein.

On reaching the central area of the swirl chamber 16, the fine air bubbles leave the swirl chamber 16 simultaneously with the contaminated liquid 12 through the second outlet 28.

An effect of the content and motion within the swirl chamber 16 is that solid contaminants within the contaminated liquid 12 may be removed by centrifugal action. Particulate contaminants, which have a specific gravity greater than a certain lower limit are forced radially outwards within the swirl chamber 16. The effectiveness of this centrifugal action is enhanced in the present invention, owing to the reduction of the specific gravity of the rotating air/liquid mixture to below 0.8, and preferably below 0.7.

An advantage of this aspect of the present invention is that particulate matter of a specific gravity equal to or slightly below the specific gravity of water may be effectively centrifuged out and settle as sludge 24 at the operative bottom of the swirl chamber 16.

Removal of sludge 24 from the swirl chamber 16 is regulated by valves to a value which ensures that there is no excessive build up of sludge 24 in the swirl chamber 16.

A further effect of the content and motion within the swirl chamber 16 is that the liquid/vapor interface provided by the fine air bubbles mixed with the contaminated liquid 12 in the swirl chamber 16 facilitates removal of contaminants within the contaminated liquid 12 by foam fractionation.

The effectiveness of foam fractionation is enhanced by the relative motion generated between the fine air bubbles and contaminated liquid 12, due to centrifugal action forcing the air bubbles inwards towards the centre of the swirl chamber 16. This relative motion, combined with the abundance of air bubbles within the swirl chamber 16, and the distribution of air bubbles throughout the contaminated liquid 12 in the upper portion of the swirl chamber 16, greatly increases the probability that surfactant contaminants in the contaminated liquid 12 will encounter a liquid/vapor interface to adhere to.

In the preferred embodiment of the separator 10, the provision of conditions which enable foam fractionation effectively to take place, allow two further types of contaminant removal to take place: firstly gas substitution, whereby substitution of dissolved gaseous contaminants within the contaminated liquid 12 by elements of air bubbles as they move relative to the contaminated liquid 12 surrounding them; secondly, desorption. Volatile liquids contained in the contaminated liquid 12 are removed by air within air bubbles as they move relative to the contaminated liquid 12 surrounding them.

The effectiveness of the separator 10 and method of the present invention in removing contaminants from contaminated liquid 12 improves:
(i) as the proportion of fine air bubbles to contaminated liquid 12 in the swirl chamber 16 is increased;
(ii) as the mean air bubble size in the swirl chamber 16 is decreased; and
(iii) as the energy in the swirl chamber 16, as reflected by rotation rate, is increased.

Operation of the flotation chamber 30 will now be described, with reference to FIGS. 1 to 4.
(i) a mixture of treated liquid and fine air bubbles leaves the swirl chamber 16 through the second outlet 28 and rises up through a cylinder 31 into the second chamber;
(ii) the mixture of treated liquid descends in the first chamber bounded by cylindrical wall 32, the rate of descent of liquid in the first chamber is arranged to be less than the rate at which the smallest air bubbles rise in the treated liquid. Typically, the rate of descent of liquid in the first chamber is 50 mm/s or less, more preferably 20 mm/s or less;
(iii) the air bubbles (typically less than 1 mm in diameter) rise in the first chamber and accumulate as foam (containing contaminants), which floats on the surface of the liquid in the first chamber;
(iv) this foam passes through the foam outlet 42 and exits the separator 10. Lid 44 serves to contain the foam within the first chamber, to prevent dispersal of contaminants into the atmosphere. Importantly, the foam should be extracted from the first chamber before the bubbles burst and release the contaminants carried thereby into the liquid in the first chamber. For a similar reason, it is important to minimise contact between foam in the first chamber and solid surfaces;
(v) the treated liquid that has descended to the bottom of the first chamber passes through the duct or orifice 38 at or near the bottom of the cylindrical wall 32 into the second chamber bounded by cylindrical walls 32 and 34, where the liquid settles;
(vi) Liquid within the second chamber that overflows the cylindrical wall 34 enters a treated liquid outlet 46, and is directed away from the separator 10.

According to a second aspect of the invention, there is provided a method for treatment of contaminated liquid 12 including the steps of:
1. charging a swirl chamber 16 with a contaminated liquid 12 via a feed inlet 20;
2. circulating the liquid 12 in the swirl chamber 16;
3. injecting (i) liquid entrained with air/gas; (ii) air/gas-entrained liquid; or (iii) air/gas in the swirl chamber 16 via injectors 18 so as to reduce the specific gravity of the contaminated liquid 12 in the swirl chamber 16 by at least 20%, preferably by at least 25%, and more preferably by at least 30%;
4. extracting liquid 12 or sludge 24 from or from near the operative bottom of the swirl chamber 16 via a first outlet 22; and
5. extracting liquid 12 from the swirl chamber 16 via a second outlet 28 located operatively above the first outlet 22.

1. A separator for treatment of a contaminated liquid, including:
a swirl chamber defining a longitudinal axis;
at least one injector for, in use, introducing: (i) liquid entrained with air/gas; (ii) air/gas-entrained liquid; or (iii) air/gas, into the swirl chamber;
a first outlet located at or near the operative bottom of the swirl chamber for, in use, removing sludge from the swirl chamber;
a second outlet located operatively above the first outlet for, in use, removing liquid from the swirl chamber;
circulating means to, in use, circulate liquid in the swirl chamber; and
an elongate body that extends from or near the operative top of the swirl chamber, along the longitudinal axis of the swirl chamber, beyond the level of the at least one injector.

2. A separator according to claim 1, wherein the operative upper portion of the swirl chamber is right circular cylindrical and the operative lower portion of the swirl chamber is right circular conical.

3. A separator according to claim 2, wherein the at least one injector injects fluid into the swirl chamber otherwise than directly towards the longitudinal axis of the swirl chamber.

4. A separator according to claim 3, wherein the angularly offset orientation of the at least one injector relative to the radius of the swirl chamber, in use, causes the contaminated liquid within the swirl chamber to swirl, and comprises the circulating means.

5. A separator according to claim 4, wherein the separator includes at least two injectors.

6. A separator according to claim 5, wherein the at least two injectors are arranged such that, in use, the direction of the liquid injected thereby is angularly offset relative to the radius of the swirl chamber by between 20 degrees and 46 degrees.

7. A separator according to claim 5, wherein the at least two injectors are arranged such that, in use, the direction of the liquid injected thereby is angularly offset relative to the radius of the swirl chamber by between 26 degrees and 40 degrees.

8. A separator according to claim 6, wherein the elongate body is right circular cylindrical.

9. A separator according to claim 8, wherein the elongate body extends into the operative lower portion of the swirl chamber.

10. A separator according to claim 9, further including a feed inlet for, in use, charging the swirl chamber with contaminated liquid.

11. A separator according to claim 10, wherein the feed inlet is arranged to, in use, direct contaminated liquid tangentially into the swirl chamber.

12. A separator according to claim 11, wherein the second outlet: (i) is located at the operative top of the swirl chamber; (ii) is concentric with the longitudinal axis of the elongate body; and (iii) has a diameter greater than the diameter of the elongate body.

13. A separator according to claim 12, further including a flotation chamber located operatively above the swirl chamber and communicating therewith via the second outlet.

14. A separator according to claim 13, wherein the flotation chamber includes: (i) a foam outlet for, in use, discharging foam from the flotation chamber; and (ii) a treated liquids outlet for discharging treated liquid from the flotation chamber.

15. A separator according to claim 14, wherein the flotation chamber comprises: (i) a first chamber for, in use, receiving liquid discharged from the swirl chamber via the second outlet, and from which the foam outlet, in use, discharges foam; and (ii) a second chamber in fluid communication with the first chamber via a duct or orifice, wherein, in use, the duct or orifice is operatively located below the foam outlet.

16. A separator according to claim 15, wherein, in use, the liquid level in the second chamber is below the level of the operative bottom of the foam outlet in the first chamber.

17. A separator according to claim 16, wherein the treated liquid outlet receives treated liquid from near the top of the second chamber.

18. A separator according to claim 17, further including a feedback pipe that extracts liquid from the flotation chamber and feeds it to the at least one injector.

19. A separator according to claim 18, wherein the feedback pipe extracts treated liquid from the second chamber of the flotation chamber.

20. A separator according to claim 19, further including at least one cylindrical shear plate concentric with the longitudinal axis of the swirl chamber, located within the lower portion of the swirl chamber, in use, to induce shear forces between the rotating contaminated liquid in this region of the swirl chamber and the cylindrical shear plate.

21. A separator according to claim 20 including a second cylindrical shear plate, the second cylindrical shear plate being concentric with the first cylindrical shear plate but having a diameter different to that of the first cylindrical shear plate.

22. A separator according to claim 21, wherein the injectors are located within the operative lower portion of the swirl chamber.

23. A separator according to claim 22, wherein the contaminated liquid is fed into the swirl chamber operatively below the level of the at least one injector.

24. A method for treatment of contaminated liquid including the steps of:
charging a swirl chamber with a contaminated liquid;
circulating the liquid in the swirl chamber; and
injecting a quantity of gas/air into the contaminated liquid in the swirl chamber so as to reduce its specific gravity by at least 20%.

25. A method according to claim 24, wherein the quantity of gas/air injected into the contaminated liquid in the swirl chamber reduces the specific gravity of the contaminated liquid by at least 30%.

26. A method according to claim 24, further including the steps of discharging: (i) sludge from the swirl chamber via a first outlet; and (ii) liquid from the swirl chamber via a second outlet operatively located above the first outlet.

27. A method according to claim 26, further including the step of separating the liquid exiting the swirl chamber via the second outlet into a foam component and a liquid component.

28. A method according to claim 27, wherein the liquid component is injected as a fluid stream back into the swirl chamber together with the gas/air.

29. A method according to claim 28, wherein the fluid stream of: (i) liquid entrained with gas/air; or (ii) gas/air, injected into the swirl chamber is not directed at the longitudinal axis of the swirl chamber.

30. A method according to claim 29, wherein at least two fluid streams are injected into the swirl chamber via injectors.

31. A method according to claim 30, wherein the direction of the fluid streams injected into the swirl chamber is offset relative to the radius of the swirl chamber by between 20 degrees and 46 degrees (α).

32. A method according to claim 31, wherein the direction of the fluid streams injected into the swirl chamber is offset relative to the radius of the swirl chamber by between 26 degrees and 40 degrees (α).

33. A method according to claim 31, wherein the injection of fluid streams into the swirl chamber causes the formation of a torus body within the contaminated liquid that rotates faster and is more aerated than the surrounding contaminated liquid.

34. A method according to claim 33, wherein the torus body has:
a major radius corresponding to:
[the radius of the swirl chamber in the area of the injectors]×sin(α); and
a minor radius corresponding to 0.5×the width of the fluid stream at a distance:
[the radius of the swirl chamber in the area of the injectors]×cos(α)
from the injector.

35. A method according to claim 34, wherein the angle α is sufficiently small to ensure that:
[the radius of the swirl chamber in the area of the injectors<[the major radius of the torus body]+[the minor radius of the torus body].

36. A method according to claim 35, wherein the radial outer peripheral surface of the torus body is spaced from the inner wall of the swirl chamber.

37. A method according to claim 36, wherein the contaminated liquid is fed into the swirl chamber operatively below the level of the injectors.
